(19) United States
(12) Patent Application Publication
(10) Pub. No.: US 2025/0067831 A1
(43) Pub. Date: Feb. 27, 2025

(54) RADIOWAVE INFORMATION OUTPUT DEVICE, RADIOWAVE INFORMATION OUTPUT METHOD, AND RECORDING MEDIUM

(71) Applicant: NEC Corporation, Minato-ku, Tokyo (JP)

(72) Inventors: Takashi Kuribara, Tokyo (JP); Kohei Sugai, Tokyo (JP); Masato Kita, Tokyo (JP); Ryosuke Kumagai, Tokyo (JP)

(73) Assignee: NEC Corporation, Minato-ku, Tokyo (JP)

(21) Appl. No.: 18/729,259

(22) PCT Filed: Feb. 16, 2022
(86) PCT No.: PCT/JP2022/006228

§ 371 Date: Jul. 16, 2024

(51) Int. Cl. G01S 3/14

(52) U.S. Cl. CPC G01S 3/14

(57) ABSTRACT

A radiowave information output device receives radiowave information for a reception radiowave being a radiowave received by a radiowave sensor, the radiowave information including identification information and position specification information relating to a transmission source of the radiowave, executes collation in such a way as to determine whether reception meta data match with collation meta data, the reception meta data being information included in the radiowave information and being identification information relating to the transmission source of the radiowave, the collation meta data being identification information relating to a transmission source of a known radiowave, estimates, for an unknown radiowave being the reception radiowave whose reception meta data do not match with any piece of the collation meta data, a position of a transmission source of the unknown radiowave, and outputs unknown radiowave information being information relating to a position of the transmission source of the unknown radiowave.

### TECHNICAL FIELD

The present invention relates to a radiowave information output device and the like.

### BACKGROUND ART

In wireless communication, one of factors that reduce throughput is radiowave interference.

When radiowave interference occurs, and throughput is reduced, quality of services to be provided via wireless communication may be degraded. Examples of degradation of service quality include disruptions in a video or audio being reproduced, degradation of control accuracy for remote control, and the like.

Thus, when radiowave interference occurs, it is desired that a measure against radiowave interference be taken for resolving the radiowave interference.

However, reduction in throughput may be caused by a factor other than radiowave interference. Thus, when a measure against radiowave interference is taken, investigation on whether radiowave interference occurs is first required.

In general, reduction in throughput is detected when degradation of service quality occurs. Further, in general, an investigator visits a site where the degradation of service quality occurs, and the investigator conducts investigation on whether radiowave interference occurs, by checking a radio status and the like in the periphery. Further, when radiowave interference occurs, an interference source is specified, and a measure against radiowave interference is taken.

Further, the related-art techniques include techniques described in PTL 1 and PTL 2.

### CITATION LIST

### Patent Literature

PTL 1: International Patent Publication No. WO2013/046849

PTL 2: Japanese Unexamined Patent Application Publication No. 2021-032664

### SUMMARY OF INVENTION

### Technical Problem

However, a general method for investigating radiowave interference as described above requires an investigator on sight, and thus requires time and labor.

As a method for reducing such time and labor, there is conceived a method in which a large number of sensors installed in a field acquire radiowave information, a management device collects the radiowave information from the sensors, and an investigator investigates radiowave interference, based on the information being collected.

However, a large number of radiowave transmission sources are present in the field. Thus, when all pieces of information being collected from the sensors are provided to a user, an excessive amount of information is provided to the user, which causes information overload for the user. As a result, it takes a significant amount of time for investigating radiowave interference or specifying an interference source.

In view of the above-mentioned problem, an object of the present invention is to provide a radiowave information output device and the like capable of outputting information for reducing time and labor for investigating radiowave interference and specifying an interference source.

### Solution to Problem

According to one aspect of the present invention, a radiowave information output device includes: a reception means for receiving radiowave information for a reception radiowave being a radiowave received by a radiowave sensor, the radiowave information including identification information relating to a transmission source of the radiowave and position specification information being information to be used for estimating a position of the transmission source of the radiowave; a collation means for executing collation in such a way as to determine whether reception meta data matches with collation meta data, the reception meta data being information included in the received radiowave information and being the identification information relating to the transmission source of the radiowave, the collation meta data being identification information relating to a transmission source of a known radiowave; an estimation means for estimating, for an unknown radiowave being the reception radiowave whose reception meta data do not match with any piece of the collation meta data, a position of a transmission source of the unknown radiowave, based on the position specification information included in the received radiowave information; and an output means for outputting unknown radiowave information being information relating to a position of the transmission source of the unknown radiowave.

Further, according to another aspect of the present invention, a radiowave information output method includes: receiving radiowave information for a reception radiowave being a radiowave received by a radiowave sensor, the radiowave information including identification information relating to a transmission source of the radiowave and position specification information being information to be used for estimating a position of the transmission source of the radiowave; executing collation in such a way as to determine whether reception meta data match with collation meta data, the reception meta data being information included in the received radiowave information and being the identification information relating to the transmission source of the radiowave, the collation meta data being identification information relating to a transmission source of a known radiowave; estimating, for an unknown radiowave being the reception radiowave whose reception meta data do not match with any piece of the collation meta data, a position of a transmission source of the unknown radiowave, based on the position specification information included in the received radiowave information; and outputting unknown radiowave information being information relating to a position of the transmission source of the unknown radiowave.

Further, according to still another aspect of the present invention, a radiowave information output program recorded in a computer-readable recording medium causes a computer to achieve: a reception function of receiving radiowave information for a reception radiowave being a radiowave received by a radiowave sensor, the radiowave information including identification information relating to a transmission source of the radiowave and position specification information being information to be used for estimating a position of the transmission source of the radiowave; a collation function of executing collation in such a way as to determine whether reception meta data match with collation meta data, the reception meta data being information included in the received radiowave information and being the identification information relating to the transmission source of the radiowave, the collation meta data being identification information relating to a transmission source of a known radiowave; an estimation function of estimating, for an unknown radiowave being the reception radiowave whose reception meta data do not match with any piece of the collation meta data, a position of a transmission source of the unknown radiowave, based on the position specification information included in the received radiowave information; and an output function of outputting unknown radiowave information being information relating to a position of the transmission source of the unknown radiowave.

Further, according to still another aspect of the present invention, a radiowave information output system includes: a reception means for receiving radiowave information for a reception radiowave being a radiowave received by a radiowave sensor, the radiowave information including identification information relating to a transmission source of the radiowave and position specification information being information to be used for estimating a position of the transmission source of the radiowave; a collation means for executing collation in such a way as to determine whether reception meta data match with collation meta data, the reception meta data being information included in the received radiowave information and being the identification information relating to the transmission source of the radiowave, the collation meta data being identification information relating to a transmission source of a known radiowave; an estimation means for estimating, for an unknown radiowave being the reception radiowave whose reception meta data do not match with any piece of the collation meta data, a position of a transmission source of the unknown radiowave, based on the position specification information included in the received radiowave information; and an output means for outputting unknown radiowave information being information relating to a position of the transmission source of the unknown radiowave.

### Advantageous Effects of Invention

According to the present invention, it is possible to output information for reducing time and labor for investigating radiowave interference and specifying an interference source.

### BRIEF DESCRIPTION OF DRAWINGS

FIG. 1 is a diagram illustrating a configuration example of a radiowave information output device according to a first example embodiment of the present invention.

FIG. 2 is a diagram illustrating an example of an operation flow of the radiowave information output device according to the first example embodiment of the present invention.

FIG. 3 is a diagram illustrating a configuration example of a system including a radiowave information output device according to a second example embodiment of the present invention.

FIG. 4 is a diagram illustrating a configuration example of the radiowave information output device according to the second example embodiment of the present invention.

FIG. 5 is a diagram illustrating an example of an image that the radiowave information output device according to the second example embodiment of the present invention causes a display device to display.

FIG. 6 is a diagram illustrating an example of an operation flow of the radiowave information output device according to the first example embodiment of the present invention.

FIG. 7 is a diagram illustrating a hardware configuration example according to each of the example embodiments of the present invention.

### EXAMPLE EMBODIMENT

### First Example Embodiment

A first example embodiment of the present invention is described.

One specific example of a radiowave information output device 10 of the first example embodiment is a radiowave information output device 20 of a second example embodiment, which is described later.

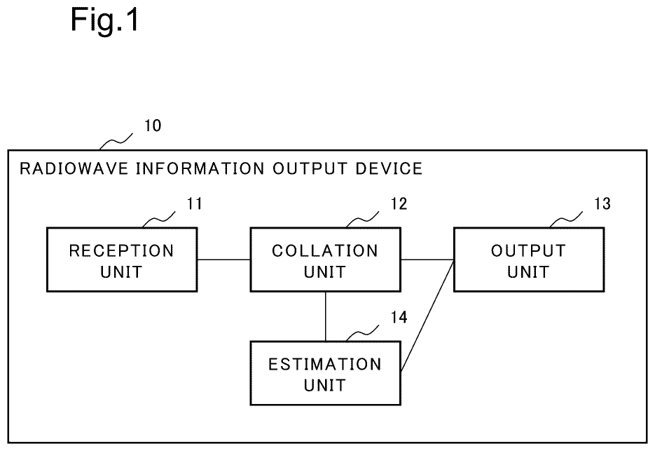

First, a configuration example of the radiowave information output device 10 of the present example embodiment described. FIG. 1 illustrates the configuration example of the radiowave information output device 10 of the present example embodiment. The radiowave information output device 10 includes a reception unit 11, a collation unit 12, an output unit 13, and an estimation unit 14.

The reception unit 11 receives radiowave information for a reception radiowave. The reception radiowave is a radiowave received by a radiowave sensor. The radiowave information is information relating to the radiowave. The radiowave information includes identification information relating to a transmission source of the radiowave and position specification information. The position specification information is information that can be used for estimating a position of the transmission source of the radiowave.

The collation unit 12 executes collation in such a way as to determine whether reception meta data matches with collation meta data. The reception meta data is information included in the received radiowave information and the identification information relating to the transmission source of the radiowave. The collation meta data is identification information relating to a transmission source of a known radiowave.

The estimation unit 14 estimates a position of a transmission source of an unknown radiowave, based on the position specification information included in the received radiowave information. The unknown radiowave is a reception radiowave whose reception meta data does not match with any piece of the collation meta data.

The output unit 13 outputs unknown radiowave information. The unknown radiowave information is information relating to the position of the transmission source of the unknown radiowave.

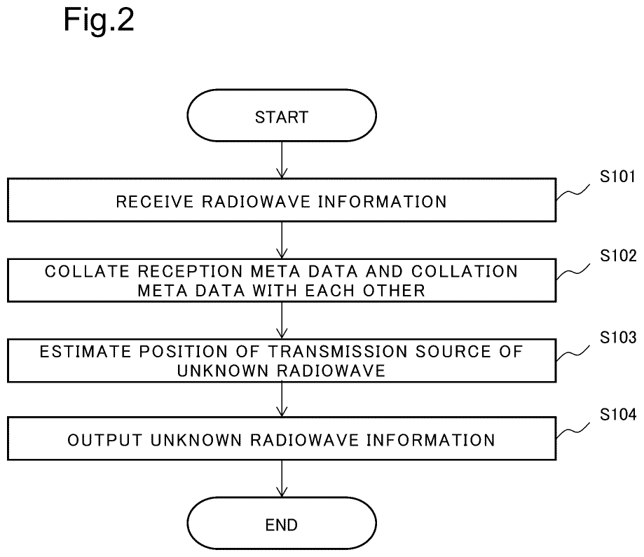

Next, an example of an operation flow of the radiowave information output device 10 of the present example embodiment is described. FIG. 2 illustrates an example of the operation flow of the radiowave information output device 10 of the present example embodiment.

The reception unit 11 receives the radiowave information for the reception radiowave (step S101). The radiowave information includes the identification information relating to the transmission source of the radiowave and the position specification information.

The collation unit 12 executes collation in such a way as to determine whether the reception meta data matches with the collation meta data (step S102).

The estimation unit 14 estimates the position of the transmission source of the unknown radiowave, based on the position specification information included in the received radiowave information (step S103). The unknown radiowave is a reception radiowave whose reception meta data does not match with any piece of the collation meta data.

The output unit 13 outputs the unknown radiowave information (step S104). the unknown radiowave information is information relating to the position of the transmission source of the unknown radiowave.

As described above, in the first example embodiment of the present invention, the radiowave information output device 10 includes the reception unit 11, the collation unit 12, the output unit 13, and the estimation unit 14. The reception unit 11 receives the radiowave information for the reception radiowave. The reception radiowave is a radiowave received by the radiowave sensor. The radiowave information includes the identification information relating to the transmission source of the radiowave and the position specification information. The position specification information is information that can be used for estimating the position of the transmission source of the radiowave. The collation unit 12 executes collation in such a way as to determine whether the reception meta data matches with the collation meta data. The reception meta data is information included in the received radiowave information, and is identification information relating to the transmission source of the radiowave. The collation meta data is identification information relating to the transmission source of the known radiowave. The estimation unit 14 estimates the position of the transmission source of the unknown radiowave, based on the position specification information included in the received radiowave information. The unknown radiowave is a reception radiowave whose reception meta data does not match with any piece of the collation meta data. The output unit 13 outputs the unknown radiowave information. The unknown radiowave information is information relating to the position of the transmission source of the unknown radiowave.

In this manner, the radiowave information output device 10 outputs the information relating to the position of the transmission source of the unknown radiowave. The radiowave information output device 10 outputs the information relating to the position of the transmission source of the unknown radiowave, and thus an investigator can refer to the information being output, determine possibility of occurrence of radiowave interference more easily, and take a measure according to the position of the transmission source. As a result, time and labor for investigating radiowave interference and specifying an interference source can be reduced. Thus, it is possible to output information for reducing time and labor for investigating radiowave interference and specifying an interference source.

### Second Example Embodiment

Next, the radiowave information output device 20 according to the second example embodiment of the present invention is described. One specific example of the radiowave information output device 10 of the first example embodiment is the radiowave information output device 20 of the second example embodiment.

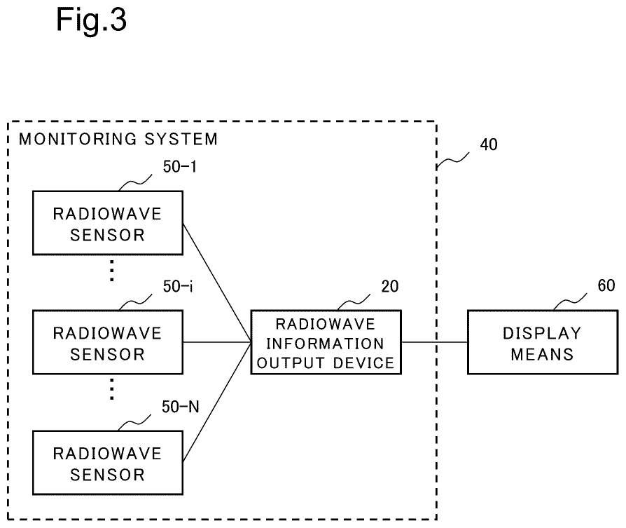

First, FIG. 3 illustrates a configuration example of a system including the radiowave information output device 20 of the present example embodiment. The radiowave information output device 20 is mutually connected to a radiowave sensor 50-i (i is an integer equal to one or more and equal to or less than N). Further, the radiowave information output device 20 is mutually connected to a display means 60. The radiowave sensor 50-i and the radiowave information output device 20 are included in a monitoring system 40.

The radiowave sensor 50-i receives a radiowave. Hereinafter, the radiowave received by the radiowave sensor 50-i is referred to as a reception radiowave. Further, the radiowave sensor 50-i outputs the radiowave information relating to the reception radiowave to the radiowave information output device 20.

The radiowave information is information relating to the radiowave. The radiowave information includes the identification information relating to the transmission source of the radiowave and the position specification information.

The position specification information is information that can be used for specifying the position of the transmission source. For example, the position specification information may include direction information indicating an arrival direction of the radiowave. For example, the radiowave sensor 50-i can estimate an arrival direction of a signal by an antenna capable of controlling directivity by beamforming or rotation. Further, the position specification information may include information to be used in a radiowave transmission position estimation method such as an angle-of-arrival (AOA) method, a power-of-arrival (POA) method, and a time-difference-of-arrival (TDOA) method. Further, when the radiowave sensor 50-i can acquire position information relating to the transmission source from the reception radiowave, the position specification information may further include the position information. For example, with regard to the transmission source of the radiowave, the position of the transmission source of the radiowave can be acquired by using the global navigation satellite system (GNSS) or the like.

The radiowave sensor 50-i may be installed in a fixed manner, or may be movable. Further, a communication method for outputting the radiowave information from the radiowave sensor 50-i to the radiowave information output device 20 may be a wired method or a wireless method.

The display means 60 is a machine interface such as a display functioning as an output device. The display means 60 displays an image. In the present example embodiment, it is assumed that the radiowave information output device 20 outputs the unknown radiowave information being information relating to the radiowave information to the display means 60. However, an output destination of the unknown radiowave information may be freely selected. The radiowave information output device 20 may output the unknown radiowave information to an output destination other than the display means 60.

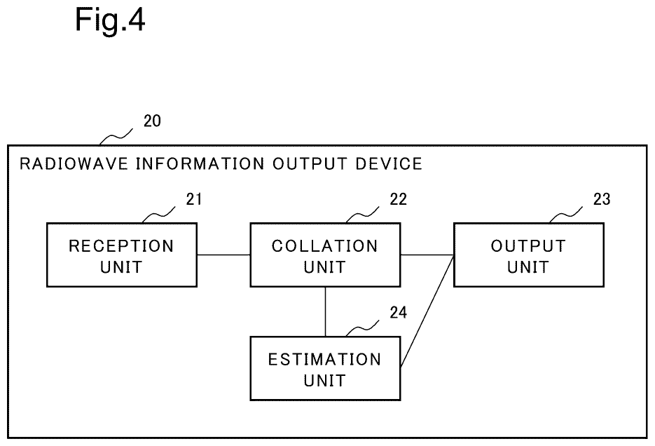

Next, FIG. 4 illustrates a configuration example of the radiowave information output device 20 of the present example embodiment. The radiowave information output device 20 of the present example embodiment includes a reception unit 21, a collation unit 22, an output unit 23, and an estimation unit 24.

The reception unit 21 receives the radiowave information relating to the reception radiowave from the radiowave sensor 50-i. The reception radiowave is a radiowave received by the radiowave sensor 50-i. The radiowave information is information relating to the radiowave. The radiowave information includes the identification information relating to the transmission source of the radiowave and the position specification information. Hereinafter, the identification information relating to the transmission source of the radiowave is referred to as radiowave identification information. Further, hereinafter, the radiowave identification information included in the radiowave information received by the reception unit 21 is referred to as reception meta data.

The radiowave identification information is information that enables identification of an individual transmission source. For example, the radiowave identification information may include international mobile equipment identity (IMEI), international mobile subscriber identity (IMSI), a media access control (MAC) address, or the like. When the transmission source is a drone, the radiowave identification information may include a remote identification (ID) being identification information relating to the drone.

Further, when the transmission source is a base station, the radiowave identification information may include a physical cell identifier (PCI). Further, the radiowave identification information may include a number for an area of beamforming, which is included in a synchronization signal (SS) block (SSB)/a physical broadcast channel (PBCH) block. The PCI or the number for the area of beamforming alone cannot specify an individual transmission source, but can narrow down individual bodies being associated therewith in combination with another piece of information. For example, when the radiowave identification information includes the PCI and the number for the area of beamforming, the transmission source being associated therewith is specified substantially uniquely.

Further, the radiowave identification information may include information based on position information relating to the transmission source. For example, when the transmission source is installed in a fixed manner, the position information relating to the transmission source may be used as the radiowave identification information. Further, when the transmission source moves in the same route, the movement route of the transmission source may be used as the radiowave identification information.

The radiowave sensor 50-i can acquire the position information relating to the transmission source, from a radiowave being transmitted from the transmission source. For example, the transmission source acquires the position of the own transmission source by using the GNSS. Further, the radiowave sensor 50-i can acquire the position information relating to the transmission source, from the signal including the position information, by monitoring the signal being transmitted from the transmission source.

Further, the radiowave identification information may include information relating to a frequency of the radiowave. For example, the radiowave identification information may include information such as a synchronization signal (SS) reference. A large number of transmission sources that use the same frequency are present, but a combination of frequency information and another piece of information, for example, position information may possibly narrow down candidates for an individual transmission source.

Further, in addition to the radiowave identification information, the radiowave information may include information relating to the radiowave being transmitted from the transmission source, such as a frequency, a modulation method, and a reception signal level at the radiowave sensor 50-i. For example, the radiowave information may include information such as reference signal received quality (SS-RSRQ).

The collation unit 22 executes collation in such a way as to determine whether the reception meta data and the collation meta data match with each other. The reception meta data is the radiowave identification information included in the radiowave information received by the reception unit 21. The collation meta data is radiowave identification information relating to a radiowave being output from a known transmission source. The known transmission source is a wireless base station that is legitimately installed, a legitimate wireless terminal, or the like. The collation meta data is stored in a storage unit (omitted in illustration). The storage unit may be provided inside or outside of the radiowave information output device 20.

When the radiowave identification information includes two or more types of meta data, the collation unit 22 determines whether the reception meta data and the collation meta data matches with each other, according to a predetermined collation condition. The collation condition is a condition relating to the meta data being used as the radiowave identification information. The collation condition is a condition that is satisfied when the collation unit 22 determines that the reception meta data and the collation meta data match with each other. The collation condition is set to a freely selected condition according to the meta data being used as the radiowave identification information.

For example, the collation condition may be satisfied when any one of a first condition and a second condition is satisfied. For example, the first condition is satisfied when any piece of meta data that can uniquely specify an individual body by itself, such as IMEI, matches. For example, the second condition may be satisfied when all pieces of meta data, which cannot uniquely specify an individual body by themselves and are included in a predetermined meta data combination, match. For example, the second condition may be satisfied when both the PCI and the number for the area of beamforming match.

The reception radiowave whose reception meta data does not match with any piece of the collation meta data is a reception radiowave for which there is no match as a result of collation with known radiowave identification information. In other words, the reception radiowave whose reception meta data does not match with any piece of the collation meta data is an unknown reception radiowave. Hereinafter, the reception radiowave whose reception meta data does not match with any piece of the collation meta data is referred to as an unknown radiowave in some cases. The unknown radiowave is a radiowave that is transmitted from an illegitimate transmission source such as an illegitimate base station and an illegitimate terminal and a radiowave whose radiowave identification information is abnormal due to some malfunction even when the radiowave is transmitted from a legitimate transmission source.

The estimation unit 24 specifies the position of the transmission source of the unknown radiowave. A method of estimating a position is described later.

The output unit 23 outputs the unknown radiowave information. The unknown radiowave information is information relating to the position of the transmission source of the reception radiowave (unknown radiowave) whose reception meta data does not match with any piece of the collation meta data.

In this manner, in the present example embodiment, the output unit 23 outputs the information relating to the position of the transmission source of the unknown radiowave as the unknown radiowave information. Thus, a user provided with the information can easily grasp presence of a radiowave transmitted from an illegitimate transmission source or an abnormal radiowave and information relating to the position. As a result, a measure against an unknown radiowave is facilitated.

The output unit 23 may prevent an output of information relating to a known reception radiowave. When an output of the information relating to the known reception radiowave is prevented, an information amount from the radiowave information output device 20 to an output destination can be reduced, and a communication load can be reduced. Further, it becomes easier for a user to select and prioritize information.

Further, the output unit 23 may output known radiowave information being information relating to the known reception radiowave, distinctively from the unknown radiowave information. The known reception radiowave is the reception radiowave whose reception meta data matches with any piece of the collation meta data.

In the present example embodiment, the output unit 23 outputs the unknown radiowave information to the display means 60. Further, in the present example embodiment, the unknown radiowave information is image information for causing the display means 60 to display the image. In other words, the output unit 23 outputs the unknown radiowave information to the display means 60, and thus the display means 60 is caused to display the image.

Next, specific examples of the image that the output unit 23 causes the display means 60 to display are described.

For example, the image may include a screen item indicating a transmission source, at a position of a transmission source of the unknown radiowave on a map. A radiowave for which the image includes the screen item indicating the transmission source is an unknown radiowave. In other words, the image includes the screen item indicating the transmission source for the reception radiowave whose reception meta data does not match with any piece of the collation meta data.

Further, the position of the transmission source is often estimated within a certain range, rather than as a pinpoint. Thus, the screen item indicating the transmission source may be displayed in a size indicating the range within which the transmission source is estimated to be present.

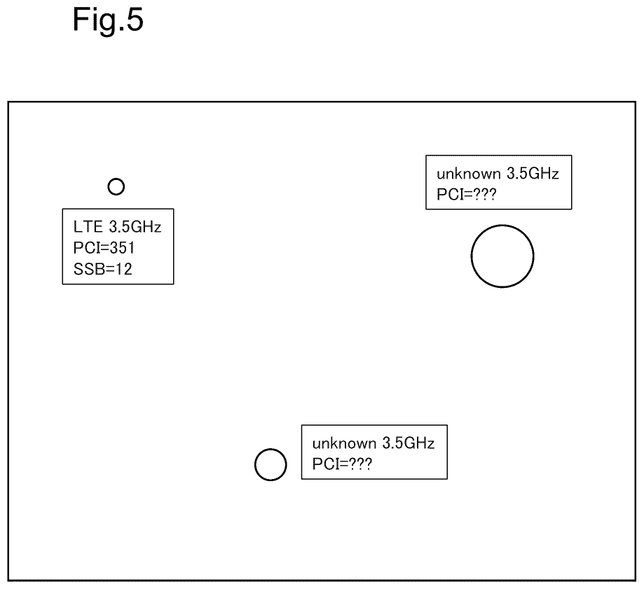

Further, for each radiowave, in the image, at least part of the radiowave information may be further displayed. For example, in the image, the reception meta data may be displayed in association with the screen item indicating the transmission source. FIG. 5 is a diagram illustrating an example of the display image. In the example of FIG. 5, the circle represents the screen item indicating the transmission source. In this manner, in the image, the screen item indicating the transmission source is arranged at the position of the transmission source on the map. Further, in the example of FIG. 5, the size of the screen item represents a range within which the transmission source is estimated to be present. Further, in the image, a type and a use frequency band of a radiowave, a PCI, and the like are displayed in association with the screen item indicating the transmission source.

Further, the output unit 23 may output the unknown radiowave information to an output destination other than the display means 60. For example, the unknown radiowave information may be data including the information relating to the position of the transmission source of the unknown radiowave. Further, the unknown radiowave information may include information relating to at least part of the radiowave information relating to the unknown radiowave.

For example, the output unit 23 may output the unknown radiowave information to an alert management device managing an alert device for broadcasting an alert. For example, the alert device broadcasts an alert through specific wireless communication or disaster prevention wireless communication.

For each alert device, the storage unit stores identification information relating to the alert device, information relating to a position of the alert device, and information relating to a notification destination of the alert management device managing the alert device. In this case, the notification destination is an output destination of the unknown radiowave information output from the output unit 23 to the alert management device. The output unit 23 refers to the information relating to the position of the alert device, and specifies the alert device that is present within a predetermined distance from the transmission source of the unknown radiowave. Further, the output unit 23 specifies the alert management device managing the alert device that is present within the predetermined distance from the transmission source of the unknown radiowave. Further, the output unit 23 outputs the unknown radiowave information to the notification destination of the specified alert management device. The unknown radiowave information in this case includes the identification information relating to the alert device that is present within the predetermined distance from the transmission source of the unknown radiowave.

In this manner, the alert management device that receives the unknown radiowave information can instruct the alert device, which is present near the transmission source of the unknown radiowave, to broadcast an alert. With this, by using the alert device that is present near the transmission source of the unknown radiowave, an alert can be issued to the transmission source of the unknown radiowave.

Further, for example, the output unit 23 may output the unknown radiowave information to a predetermined the notification destination such as a communication provider, and thus notify the communication provider or the like of presence of the unknown radiowave.

For example, for each communication provider, the storage unit stores information relating to the notification destination and information relating to a frequency band used in services provided by the communication provider, in advance. In this case, the notification destination is an output destination of the unknown radiowave information being output from the output unit 23 to the communication provider. The output unit 23 refers to the information relating to the frequency band used in the services provided by the communication provider, and specifies the communication provider whose frequency band used in the services being provided includes a frequency used in the unknown radiowave. Further, the output unit 23 outputs the unknown radiowave information to a notification destination of the specified communication provider. In this case, the unknown radiowave whose information is included in the unknown radiowave information is the unknown radiowave using the frequency included in the frequency band used in the services provided by the specified communication provider. Further, the unknown radiowave information may include at least part of the radiowave information relating to the unknown radiowave using the frequency being included in the frequency band used in the services provided by the communication provider. For example, the unknown radiowave information may include information relating to a frequency used in the unknown radiowave and the like.

In this manner, the communication provider can be provided with the information relating to the position of the transmission source of the unknown radiowave that possibly acts as an interference wave against the services provided by the communication provider. Further, the communication provider can grasp possibility that radiowave interference occurs due to the unknown radiowave, and can take a measure.

Further, for example, the output unit 23 may notify the notification destination of presence of the unknown radiowave, by outputting the unknown radiowave information to the notification destination associated with the position of the transmission source of the unknown radiowave.

For example, the storage unit stores a correlation between notification destination information and area information, in advance. The output unit 23 refers to the correlation between the notification destination information and the area information, and specifies the notification destination belonging to the area including the position of the transmission source of the unknown radiowave. Further, the output unit 23 outputs the unknown radiowave information to the specified notification destination. In this case, the unknown radiowave whose information is included in the unknown radiowave information is the unknown radiowave from the transmission source at the position included in the area associated with the notification destination. Further, the unknown radiowave information may include at least part of the radiowave information relating to the unknown radiowave. For example, the unknown radiowave information may include the information relating to the frequency used in the unknown radiowave, the information relating to the position of the transmission source of the unknown radiowave, and the like.

In this manner, the information relating to the unknown radiowave present within the area associated with the notification destination can be provided to the notification destination. Further, the notification destination can grasp possibility that radiowave interference occurs due to the unknown radiowave, and can take a measure. For example, an airport administrator or the like can be notified of presence of an unknown radiowave in an airport.

Next, the method of estimating the position of the transmission source of the unknown radiowave is described. As the method of estimating the position of the transmission source, a freely selected method may be used. For example, for estimation of the position of the transmission source, a radiowave transmission position estimation method such as an AOA method, a POA method, and a TDOA method may be used. Further, when the radiowave information received by the reception unit 21 includes position information relating to the transmission source, which is acquired by the transmission source by using the GNSS, the position information may be used.

One example of the method of estimating the position of the transmission source is described. In this example, the radiowave information received by the reception unit 21 includes a frequency of a reception signal, a modulation method, and position specification information. Further, the position specification information includes the direction information indicating the arrival direction of the radiowave.

First, the estimation unit 24 groups the radiowave sensor 50-1 to the radiowave sensor 50-N that are sensors receiving a radiowave from the same transmission source. A group being generated through grouping is a group of the radiowave sensors that are estimated to receive the same radiowave. One radiowave sensor can receive one or two or more radiowaves, and hence may possibly belong to a plurality of groups. The estimation unit 24 assumes that one radiowave sensor and another radiowave sensor, which satisfies both of the following conditions, are sensors receiving a radiowave from the same transmission source. The first condition is satisfied when frequencies and modulation methods of the reception radiowaves are the same. Further, the second condition is satisfied when a distance between the radiowave sensors falls within a predetermined range. The storage unit stores information relating to a position of each of the radiowave sensors 50-i.

Next, for each group, the estimation unit 24 estimates, as the position of the transmission source, an intersection of linear lines extended from the radiowave sensors in the arrival directions of the radiowave. For example, when the intersection is not determined uniquely, the estimation unit 24 estimates a region including two or more intersections, as the position of the transmission source. For example, the estimation unit 24 may assume that a minimum circle including the two or more intersections is a region being estimated as the position of the transmission source. Further, when the number of radiowave sensors included in a group is one, the estimation unit 24 may not estimate the position of the transmission source, or may estimate the position of the transmission source by a freely selected method. For example, the estimation unit 24 may assume that a region including a linear line having a predetermined length, which is extended from the position of the radiowave sensor in the arrival direction of the radiowave, is a region being estimated as the position of the transmission source.

Further, for estimation of the position of the transmission source, the estimation unit 24 may use information relating to the likelihood of the arrival direction of the radiowave. For example, when the arrival direction of the radiowave is estimated, the radiowave sensor 50-i further calculates the likelihood of the arrival direction. For example, the likelihood may be a value that is increased as a reception signal level is higher. In this case, the radiowave information being transmitted from the radiowave sensor 50-i to the radiowave information output device 20 includes the position specification information including the direction information and the information relating to the likelihood. Further, when a plurality of radiowave sensors belong to a group, and a plurality of intersections are present, the estimation unit 24 may estimate the position of the transmission source without using the direction information relating to the reception radiowave, the direction information having the likelihood lower than a predetermined standard.

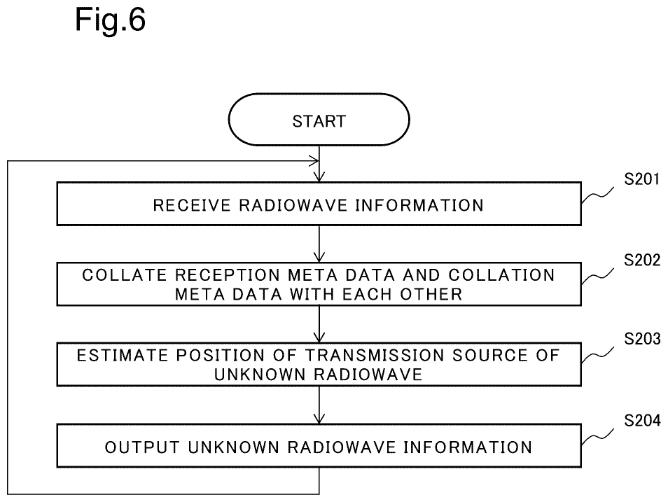

Next, an example of an operation flow of the radiowave information output device 20 of the present example embodiment is described. FIG. 6 illustrates an example of the operation flow of the radiowave information output device 20 of the present example embodiment.

The reception unit 21 receives the radiowave information from the radiowave sensor 50-i (step S201). In the present example embodiment, the radiowave information are transmitted at a predetermined interval from the radiowave sensor 50-i.

The collation unit 22 collates the reception meta data and the collation meta data with each other (step S202). In the present example embodiment, collation is executed at a predetermined interval.

The estimation unit 24 estimates the position of the transmission source of the reception radiowave (unknown radiowave) whose reception meta data does not match with any piece of the collation meta data (step S203). When the position information relating to the transmission source, which is acquired by the transmission source by using the GNSS or the like, is included in the position specification information, the estimation unit 24 may not execute estimation of the position of the transmission source.

Further, the output unit 23 outputs the unknown radiowave information (step S204). In the present example embodiment, the output unit 23 outputs the unknown radiowave information at a predetermined interval. The output unit 23 may output the unknown radiowave information at a freely selected timing instead of at a predetermined interval. For example, the output unit 23 may output the unknown radiowave information only when the unknown radiowave is present. Further, for example, when the unknown radiowave is not present, the output unit 23 may output the unknown radiowave information indicating that the unknown radiowave is not present. Further, the output unit 23 may output the unknown radiowave information when a device being an output destination of the unknown radiowave information issues a request.

As described above, in the second example embodiment of the present invention, the radiowave information output device 20 includes the reception unit 21, the collation unit 22, the output unit 23, and the estimation unit 24. The reception unit 21 receives the radiowave information for the reception radiowave. The reception radiowave is a radiowave received by the radiowave sensor. The radiowave information includes the identification information relating to the transmission source of the radiowave and the position specification information. The position specification information is information that can be used for estimating the position of the transmission source of the radiowave. The collation unit 22 executes collation in such a way as to determine whether the reception meta data matches with the collation meta data. The reception meta data is information included in the received radiowave information received and the identification information relating to the transmission source of the radiowave. The collation meta data is identification information relating to the transmission source of the known radiowave. The estimation unit 24 estimates the position of the transmission source of the unknown radiowave, based on the position specification information included in the received radiowave information. The unknown radiowave is a reception radiowave whose reception meta data does not match with any piece of the collation meta data. The output unit 23 outputs the unknown radiowave information. The unknown radiowave information is information relating to the position of the transmission source of the unknown radiowave.

In this manner, the radiowave information output device 20 outputs the information relating to the position of the transmission source of the unknown radiowave. The radiowave information output device 20 outputs the information relating to the position of the transmission source of the unknown radiowave, and thus an investigator can refer to the information being output, can determine possibility of occurrence of radiowave interference more easily, and can take a measure according to the position of the transmission source. As a result, time and labor for investigating radiowave interference and specifying an interference source can be reduced. Thus, it is possible to output information for reducing time and labor for investigating radiowave interference and specifying an interference source.

Further, in the present example embodiment, the position specification information includes information relating to the arrival direction of the radiowave. With this, the estimation unit 24 can estimate the position of the transmission source of the radiowave, based on the arrival direction of the radiowave.

Further, in the present example embodiment, the output unit 23 specifies the communication provider whose frequency band used in the services being provided the communication provider includes the frequency used in the unknown radiowave. Further, the output unit 23 outputs the unknown radiowave information to the notification destination of the specified communication provider. The unknown radiowave information includes the information relating to the position of the transmission source of the unknown radiowave that uses the frequency included in the frequency band used in the services provided by the specified communication provider. With this, the communication provider can be provided with the information relating to the position of the transmission source of the unknown radiowave that possibly acts as an interference wave against the services provided by the communication provider. Further, the communication provider can grasp possibility that radiowave interference occurs due to the unknown radiowave, and can take a measure.

Further, in the present example embodiment, the output unit 23 outputs the unknown radiowave information to the display means for displaying an image. Further, the unknown radiowave information is the image information for causing the display means to display an image. Further, the image includes the screen item indicating the transmission source, at the screen item indicating the transmission source on the map. With this, an investigator who confirms the display can easily grasp the position of the transmission source of the unknown radiowave, and hence time and labor for investigating radiowave interference or specifying an interference source can be reduced.

Further, in the present example embodiment, the output unit 23 specifies the alert device that is present within the predetermined distance from the transmission source of the unknown radiowave. Further, the output unit 23 outputs the unknown radiowave information to the notification destination of the alert management device managing the specified alert device. The unknown radiowave information includes the identification information relating to the alert device that is present within the predetermined distance from the transmission source of the unknown radiowave. The alert device broadcasts an alert. With this, the alert management device that receives the unknown radiowave information can instruct the alert device that is present near the transmission source of the unknown radiowave, to broadcast an alert. With this, by using the alert device that is present near the transmission source of the unknown radiowave, an alert can be issued to the transmission source of the unknown radiowave.

Further, in the present example embodiment, the output unit 23 refers to the correlation between the notification destination information and the area information, specifies the notification destination belonging to the area including the position of the transmission source of the unknown radiowave, and outputs the unknown radiowave information to the specified notification destination. With this, the information the unknown radiowave present within the area associated with the notification destination can be provided to the notification destination. Further, at the notification destination, possibility that radiowave interference occurs due to the unknown radiowave can be grasped, and a measure can be taken.

### Hardware Configuration Example

Description is made on a configuration example of hardware resources for achieving the above-mentioned radiowave information output device (10, 20) according to each of the example embodiments of the present invention by using one information processing device (computer). The radiowave information output device may be achieved physically or functionally by using at least two information processing devices. Further, the radiowave information output device may be achieved as a dedicated device. Further, only some of the functions of the radiowave information output device may be achieved by using the information processing devices.

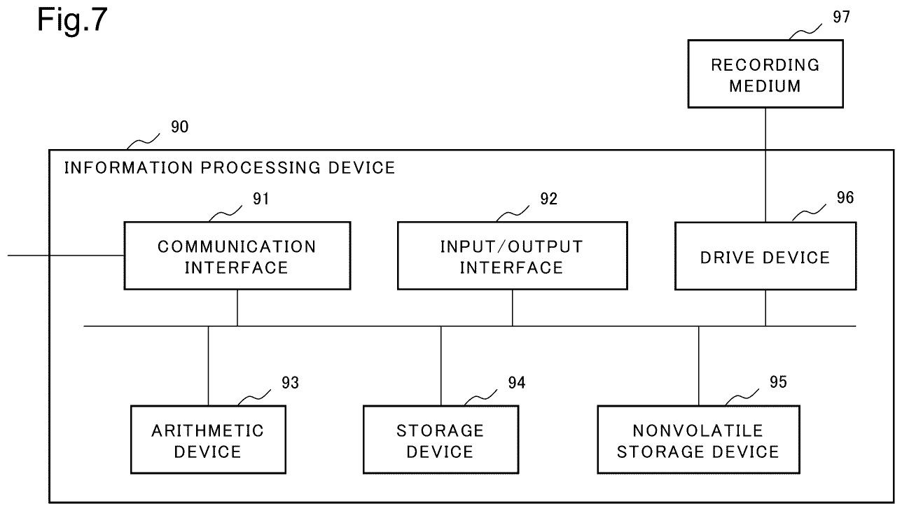

FIG. 7 is a diagram schematically illustrating a hardware configuration example of an information processing device capable of achieving the radiowave information output device according to each of the example embodiments of the present invention. An information processing device 90 includes a communication interface 91, an input/output interface 92, an arithmetic device 93, a storage device 94, a nonvolatile storage device 95, and a drive device 96.

For example, the reception unit 11 and the output unit 13 in FIG. 1 can be achieved by the communication interface 91 and the arithmetic device, and the collation unit 12 and the estimation unit 14 can be achieved by the arithmetic device 93.

The communication interface 91 is a communication means for causing the radiowave information output device of each of the example embodiments to communicate with an external device in a wired and/or wireless manner. When the radiowave information output device is achieved by using at least two information processing devices, those devices may be connected to each other in a communicable manner via the communication interface 91.

The input/output interface 92 is a human machine interface including a keyboard being an example of an input device, a display being an output device, and the like.

The arithmetic device 93 is achieved by an arithmetic processing device such as a general central processing unit (CPU) and a microprocessor and a plurality of electric circuits. For example, the arithmetic device 93 is capable of reading various programs stored in the nonvolatile storage device 95 into the storage device 94 and executing processing according to the read program.

The storage device 94 is a memory device such as a random access memory (RAM) to which the arithmetic device 93 can refer, and stores a program, various data, and the like. The storage device 94 may be a volatile memory device.

For example, the nonvolatile storage device 95 is a nonvolatile storage device such as a read only memory (ROM) and a flash memory, and is capable of storing various programs, data, and the like.

The drive device 96 is a device that execute processing of reading and writing data with respect to a recording medium 97, which is described later, for example.

For example, the recording medium 97 is a freely selected recording medium capable of recording data, such as an optical disk, a magneto-optical disk, and a semi-conductor flash memory.

For example, each of the example embodiments of the present invention may be achieved by configuring the radiowave information output device by the information processing device 90 illustrated in FIG. 7 and supplying a program for achieving the functions described in each of the above-mentioned example embodiments to the radiowave information output device.

In this case, the program supplied to the radiowave information output device is executed by the arithmetic device 93, and thus the example embodiments can be achieved. Further, some of the functions instead of all the functions of the radiowave information output device may be configured by the information processing device 90.

Moreover, the above-mentioned program is stored in the recording medium 97, and the radiowave information output device may be configured in such a way that the above-mentioned program is stored as appropriate in the nonvolatile storage device 95 at the time of shipping or operating the radiowave information output device. In this case, as the method of supplying the above-mentioned program, there may be adopted a method of installing the program in the radiowave information output device by using an appropriate jig at the time of manufacturing before shipping or at the time of operation. Further, as the method of supplying the above-mentioned program, there may be adopted a general procedure such as a method of downloading the program from the outside via a communication line such as the Internet.

The whole or a part of the example embodiments described above can be described as, but not limited to, the following supplementary notes.

### Supplementary Note 1

A radiowave information output device comprising:
a reception means for receiving radiowave information for a reception radiowave being a radiowave received by a radiowave sensor, the radiowave information including identification information relating to a transmission source of the radiowave and position specification information being information to be used for estimating a position of the transmission source of the radiowave;
a collation means for executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
an estimation means for estimating, for an unknown radiowave being the reception radiowave whose reception meta data do not match with any piece of the collation meta data, a position of a transmission source of the unknown radiowave, based on the position specification information included in the received radiowave information; and
an output means for outputting unknown radiowave information being information relating to a position of the transmission source of the unknown radiowave.

### Supplementary Note 2

The radiowave information output device according to Supplementary note 1, in which
the position specification information includes information relating to an arrival direction of the radiowave.

### Supplementary Note 3

The radiowave information output device according to Supplementary note 1 or 2, in which
the output means specifies a communication provider whose frequency band used in a service provided by the communication provider includes a frequency used in the unknown radiowave, and outputs the unknown radiowave information to a notification destination of the specified communication provider, and
the unknown radiowave information includes information relating to a position of the transmission source of the unknown radiowave using a frequency included in a frequency band used in a service provided by the specified communication provider.

### Supplementary Note 4

The radiowave information output device according to Supplementary note 1 or 2, in which
the output means outputs the unknown radiowave information to a display means for displaying an image,
the unknown radiowave information is image information for causing the display means to display the image, and
the image includes a screen item indicating a transmission source, at a position of a transmission source of the unknown radiowave on a map.

### Supplementary Note 5

The radiowave information output device according to Supplementary note 1 or 2, in which
the output means specifies an alert device being present within a predetermined distance from a transmission source of the unknown radiowave, and outputs the unknown radiowave information to a notification destination of an alert management device managing the specified alert device, and
the unknown radiowave information includes identification information relating to the alert device being present within a predetermined distance from the transmission source of the unknown radiowave, and
the alert device broadcasts an alert.

### Supplementary Note 6

The radiowave information output device according to Supplementary note 1 or 2, in which
the output means refers to a correlation between information relating to a notification destination and information relating to an area, specifies the notification destination belonging to the area including a position of the transmission source of the unknown radiowave, and outputs the unknown radiowave information to the specified notification destination.

### Supplementary Note 7

A radiowave information output method comprising:
receiving radiowave information for a reception radiowave being a radiowave received by a radiowave sensor, the radiowave information including identification information relating to a transmission source of the radiowave and position specification information being information to be used for estimating a position of the transmission source of the radiowave;
executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
estimating, for an unknown radiowave being the reception radiowave whose reception meta data do not match with any piece of the collation meta data, a position of a transmission source of the unknown radiowave, based on the position specification information included in the received radiowave information; and
outputting unknown radiowave information being information relating to a position of the transmission source of the unknown radiowave.

### Supplementary Note 8

The radiowave information output method according to Supplementary note 7, in which
the position specification information includes information relating to an arrival direction of the radiowave.

### Supplementary Note 9

The radiowave information output method according to Supplementary note 7 or 8, in which
a communication provider whose frequency band used in a service provided by the communication provider includes a frequency used in the unknown radiowave is specified, and the unknown radiowave information is output to a notification destination of the specified communication provider, and
the unknown radiowave information includes information relating to a position of the transmission source of the unknown radiowave using a frequency being included in a frequency band used in a service provided by the specified communication provider.

### Supplementary Note 10

The radiowave information output method according to Supplementary note 7 or 8, in which
the unknown radiowave information is output to a display means for displaying an image,
the unknown radiowave information is image information for causing the display means to display the image, and
the image includes a screen item indicating a transmission source, at a position of a transmission source of the unknown radiowave on a map.

### Supplementary Note 11

The radiowave information output method according to Supplementary note 7 or 8, in which
an alert device being present within a predetermined distance from a transmission source of the unknown radiowave is specified, and the unknown radiowave information is output to a notification destination of an alert management device managing the specified alert device, and
the unknown radiowave information includes identification information relating to the alert device being present within a predetermined distance from the transmission source of the unknown radiowave, and
the alert device broadcasts an alert.

### Supplementary Note 12

The radiowave information output method according to Supplementary note 7 or 8, in which
a correlation between information relating to a notification destination and information relating to an area is referred to, the notification destination belonging to the area including a position of the transmission source of the unknown radiowave is specified, and the unknown radiowave information is output to the specified notification destination.

### Supplementary Note 13

A computer-readable recording medium recording a radiowave information output program causing a computer to achieve:
a reception function of receiving radiowave information for a reception radiowave being a radiowave received by a radiowave sensor, the radiowave information including identification information relating to a transmission source of the radiowave and position specification information being information to be used for estimating a position of the transmission source of the radiowave;
a collation function of executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
an estimation function of estimating, for an unknown radiowave being the reception radiowave whose reception meta data do not match with any piece of the collation meta data, a position of a transmission source of the unknown radiowave, based on the position specification information included in the received radiowave information; and
an output function of outputting unknown radiowave information being information relating to a position of the transmission source of the unknown radiowave.

### Supplementary Note 14

The computer-readable recording medium recording the radiowave information output program according to Supplementary note 13, in which
the position specification information includes information relating to an arrival direction of the radiowave.

### Supplementary Note 15

The computer-readable recording medium recording the radiowave information output program according to Supplementary note 13 or 14, in which
the output function specifies a communication provider whose frequency band used in services provided by the communication provider includes a frequency used in the unknown radiowave, and outputs the unknown radiowave information to a notification destination of the specified communication provider, and
the unknown radiowave information includes information relating to a position of the transmission source of the unknown radiowave using a frequency included in a frequency band used in a service provided by the specified communication provide.

### Supplementary Note 16

The computer-readable recording medium recording the radiowave information output program according to Supplementary note 13 or 14, in which
the output function outputs the unknown radiowave information to a display means for displaying an image,
the unknown radiowave information is image information for causing the display means to display the image, and
the image includes a screen item indicating a transmission source, at a position of a transmission source of the unknown radiowave on a map.

### Supplementary Note 17

The computer-readable recording medium recording the radiowave information output program according to Supplementary note 13 or 14, in which
the output function specifies an alert device being present within a predetermined distance from a transmission source of the unknown radiowave, and outputs the unknown radiowave information to a notification destination of an alert management device managing the specified alert device, and
the unknown radiowave information includes identification information relating to the alert device being present within a predetermined distance from the transmission source of the unknown radiowave, and
the alert device broadcasts an alert.

### Supplementary Note 18

The computer-readable recording medium recording the radiowave information output program according to Supplementary note 13 or 14, in which
the output function refers to a correlation between information relating to a notification destination and information relating to an area, specifies the notification destination belonging to the area including a position of the transmission source of the unknown radiowave, and outputs the unknown radiowave information to the specified notification destination.

### Supplementary Note 19

A radiowave information output system comprising:
a reception means for receiving radiowave information for a reception radiowave being a radiowave received by a radiowave sensor, the radiowave information including identification information relating to a transmission source of the radiowave and position specification information being information to be used for estimating a position of the transmission source of the radiowave;
a collation means for executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
an estimation means for estimating, for an unknown radiowave being the reception radiowave whose reception meta data do not match with any piece of the collation meta data, a position of a transmission source of the unknown radiowave, based on the position specification information included in the received radiowave information; and
an output means for outputting unknown radiowave information being information relating to a position of the transmission source of the unknown radiowave.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20 Radiowave information output device
11, 21 Reception unit
12, 22 Collation unit
13, 23 Output unit
14, 24 Estimation unit
40 Monitoring system
50-i Radiowave sensor
60 Display means
90 Information processing device
91 Communication interface
92 Input/output interface
93 Arithmetic device
94 Storage device
95 Nonvolatile storage device
96 Drive device
97 Recording medium

What is claimed is:

1. A radiowave information output device comprising one or more memories storing instructions and one or more processors configured to execute the instructions to:
receive radiowave information for a reception radiowave being a radiowave received by a radiowave sensor, the radiowave information including identification information relating to a transmission source of the radiowave and position specification information being information to be used for estimating a position of the transmission source of the radiowave;
execute collation in such a way as to determine whether reception meta data match with collation meta data, the reception meta data being information included in the received radiowave information and being identification information relating to the transmission source of the radiowave, the collation meta data being identification information relating to a transmission source of a known radiowave;
estimate, for an unknown radiowave being the reception radiowave whose reception meta data do not match with any piece of the collation meta data, a position of a transmission source of the unknown radiowave, based on the position specification information included in the received radiowave information; and
output unknown radiowave information being information relating to a position of the transmission source of the unknown radiowave.

2. The radiowave information output device according to claim 1, wherein
the position specification information includes information relating to an arrival direction of the radiowave.

3. The radiowave information output device according to claim 1, wherein
a communication provider whose frequency band used in a service provided by the communication provider includes a frequency used in the unknown radiowave is specified, and the unknown radiowave information is output to a notification destination of the specified communication provider, and
the unknown radiowave information includes information relating to a position of the transmission source of the unknown radiowave using a frequency included in a frequency band used in a service provided by the specified communication provider.

4. The radiowave information output device according to claim 1, wherein
the unknown radiowave information is output to display means for displaying an image,
the unknown radiowave information is image information for causing the display means to display the image, and
the image includes a screen item indicating a transmission source, at a position of a transmission source of the unknown radiowave on a map

5. The radiowave information output device according to claim 1, wherein
an alert device being present within a predetermined distance from a transmission source of the unknown radiowave is specified, and the unknown radiowave information is output to a notification destination of an alert management device managing the specified alert device, and
the unknown radiowave information includes identification information relating to the alert device being present within a predetermined distance from the transmission source of the unknown radiowave, and
the alert device broadcasts an alert.

6. The radiowave information output device according to claim 1, wherein
a correlation between information relating to a notification destination and information relating to an area is referred to, the notification destination belonging to the area including a position of the transmission source of the unknown radiowave is specified, and the unknown radiowave information is output to the specified notification destination.

7. A radiowave information output method comprising:
receiving radiowave information for a reception radiowave being a radiowave received by a radiowave sensor, the radiowave information including identification information relating to a transmission source of the radiowave and position specification information being information to be used for estimating a position of the transmission source of the radiowave;
executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
estimating, for an unknown radiowave being the reception radiowave whose reception meta data do not match with any piece of the collation meta data, a position of a transmission source of the unknown radiowave, based on the position specification information included in the received radiowave information; and
outputting unknown radiowave information being information relating to a position of the transmission source of the unknown radiowave.

8. The radiowave information output method according to claim 7, wherein
the position specification information includes information relating to an arrival direction of the radiowave.

9. The radiowave information output method according to claim 7, wherein
a communication provider whose frequency band used in a service provided by the communication provider includes a frequency used in the unknown radiowave is specified, and the unknown radiowave information is output to a notification destination of the specified communication provider, and
the unknown radiowave information includes information relating to a position of the transmission source of the unknown radiowave using a frequency included in a frequency band used in a service provided by the specified communication provider.

10. The radiowave information output method according to claim 7, wherein
the unknown radiowave information is output to display means for displaying an image,
the unknown radiowave information is image information for causing the display means to display the image, and
the image includes a screen item indicating a transmission source, at a position of a transmission source of the unknown radiowave on a map

11. The radiowave information output method according to claim 7, wherein
an alert device being present within a predetermined distance from a transmission source of the unknown radiowave is specified, and the unknown radiowave information is output to a notification destination of an alert management device managing the specified alert device, and
the unknown radiowave information includes identification information relating to the alert device being present within a predetermined distance from the transmission source of the unknown radiowave, and
the alert device broadcasts an alert.

12. The radiowave information output method according to claim 7, wherein
a correlation between information relating to a notification destination and information relating to an area is referred to, the notification destination belonging to the area including a position of the transmission source of the unknown radiowave is specified, and the unknown radiowave information is output to the specified notification destination.

13. A non-transitory computer-readable recording medium recording a radiowave information output program causing a computer to achieve:
a reception function of receiving radiowave information for a reception radiowave being a radiowave received by a radiowave sensor, the radiowave information including identification information relating to a transmission source of the radiowave and position specification information being information to be used for estimating a position of the transmission source of the radiowave;
a collation function of executing collation in such a way as to determine whether reception meta data match with collation meta data, the reception meta data being information included in the received radiowave information and being identification information relating to the transmission source of the radiowave, the collation meta data being identification information relating to a transmission source of a known radiowave;
an estimation function of estimating, for an unknown radiowave being the reception radiowave whose reception meta data do not match with any piece of the collation meta data, a position of a transmission source of the unknown radiowave, based on the position specification information included in the received radiowave information; and
an output function of outputting unknown radiowave information being information relating to a position of the transmission source of the unknown radiowave.

14. The non-transitory computer-readable recording medium recording the radiowave information output program according to claim 13, wherein
the position specification information includes information relating to an arrival direction of the radiowave.

15. The non-transitory computer-readable recording medium recording the radiowave information output program according to claim 13, wherein
the output function specifies a communication provider whose frequency band used in a service provided by the communication provider includes a frequency used in the unknown radiowave, and outputs the unknown radiowave information to a notification destination of the specified communication provider, and
the unknown radiowave information includes information relating to a position of the transmission source of the unknown radiowave using a frequency included in a frequency band used in a service provided by the specified communication provider.

16. The non-transitory computer-readable recording medium recording the radiowave information output program according to claim 13, wherein
the output function outputs the unknown radiowave information to display means for displaying an image,
the unknown radiowave information is image information for causing the display means to display the image, and
the image includes a screen item indicating a transmission source, at a position of a transmission source of the unknown radiowave on a map

17. The non-transitory computer-readable recording medium recording the radiowave information output program according to claim 13, wherein
the output function specifies an alert device being present within a predetermined distance from a transmission source of the unknown radiowave, and outputs the unknown radiowave information to a notification destination of an alert management device managing the specified alert device, and
the unknown radiowave information includes identification information relating to the alert device being present within a predetermined distance from the transmission source of the unknown radiowave, and
the alert device broadcasts an alert.

18. The non-transitory computer-readable recording medium recording the radiowave information output program according to claim 13, wherein
the output function refers to a correlation between information relating to a notification destination and information relating to an area, specifies the notification destination belonging to the area including a position of the transmission source of the unknown radiowave, and outputs the unknown radiowave information to the specified notification destination.

19. (canceled)
